(19) United States
(12) Patent Application Publication
(10) Pub. No.: US 2015/0220418 A1
(43) Pub. Date: Aug. 6, 2015

(54) SHREDDER NETWORK AND METHOD OF SHREDDER MANAGEMENT

(71) Applicant: ACCO Brands Corporation, Lake Zurich, IL (US)

(72) Inventors: Paul A. Aries, Brierley Hill (GB); Michael Stranders, Tring (GB)

(21) Appl. No.: 14/613,985

(22) Filed: Feb. 4, 2015

Related U.S. Application Data
(60) Provisional application No. 61/935,993, filed on Feb. 5, 2014.

(51) Int. Cl. G06F 11/34; H04W 4/00; G06Q 30/04; G06Q 10/00; B02C 18/00; H04L 29/08

(52) U.S. Cl. CPC G06F 11/3438; B02C 18/0007; H04L 67/12; G06Q 30/04; G06Q 10/20; H04W 4/005

(57) ABSTRACT

A shredder network includes a server system, a network management system in communication with the server system for processing information, a plurality of shredders. Each of the plurality of shredders includes a cutting mechanism operable to shred material fed thereto, a controller which receives information from a plurality of sensors, and a communication module establishing communication protocol between the shredder and one of the server system and the network management system.

### CROSS-REFERENCE TO RELATED APPLICATIONS

This application claims priority to U.S. Provisional Patent Application No. 61/935,993, filed Feb. 5, 2014, the entire contents of which are incorporated by reference herein.

### BACKGROUND

The present invention relates to shredding machines (“shredders”), for example those used in homes and offices for destroying sensitive or confidential materials, including paper documents, compact discs, credit cards, USB memory devices, hard drives, etc.

### SUMMARY

In one aspect, the invention provides a shredder network which includes a server system, a network management system in communication with the server system for processing information, and a plurality of shredders. Each of the plurality of shredders includes a cutting mechanism operable to shred material fed thereto, a controller which receives information from a plurality of sensors, and a communication module establishing communication protocol between the shredder and one of the server system and the network management system.

In another aspect, the invention provides a method including providing a plurality of shredders for shredding materials. Information is collected from each of the plurality of shredders and stored. At least a portion of the information collected from the shredders is sent to a network management system, and the information collected is analyzed to provide services, including generating an invoice based on the information collected.

Other aspects of the invention will become apparent by consideration of the detailed description and accompanying drawings.

### BRIEF DESCRIPTION OF THE DRAWINGS

FIG. 1 is a perspective view of a shredder including a communication module.

FIG. 2 is a front view of an interactive user interface of the shredder of FIG. 1.

FIG. 3 is a schematic view of a shredder network according to one embodiment of the invention.

FIG. 4 is a schematic view of output data signals from the shredder network of FIG. 3.

FIG. 5 is a schematic view of a shredder network according to one embodiment of the invention.

FIG. 6 is a schematic view of a shredder network according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

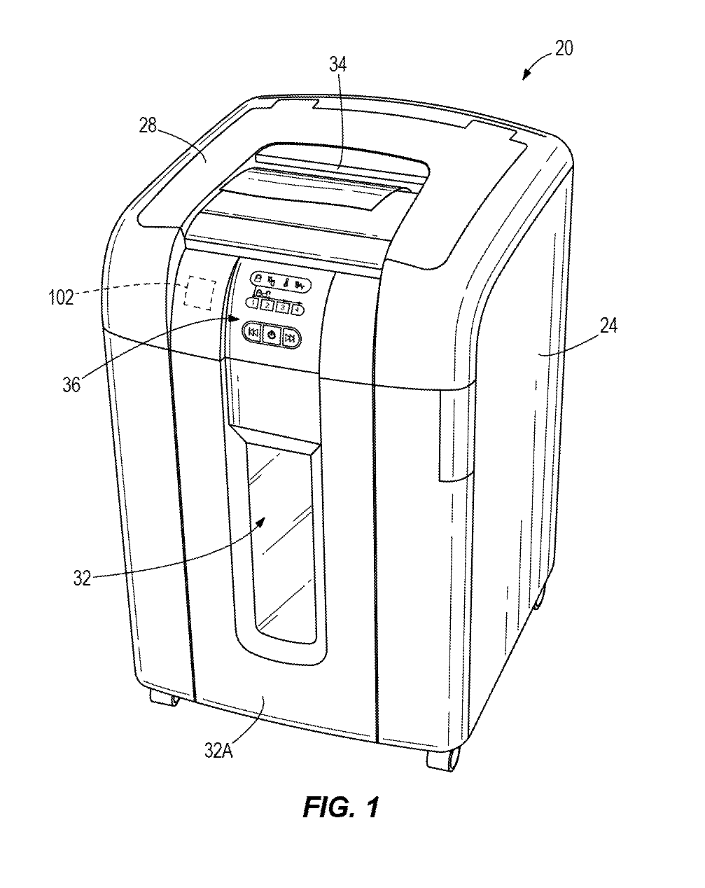

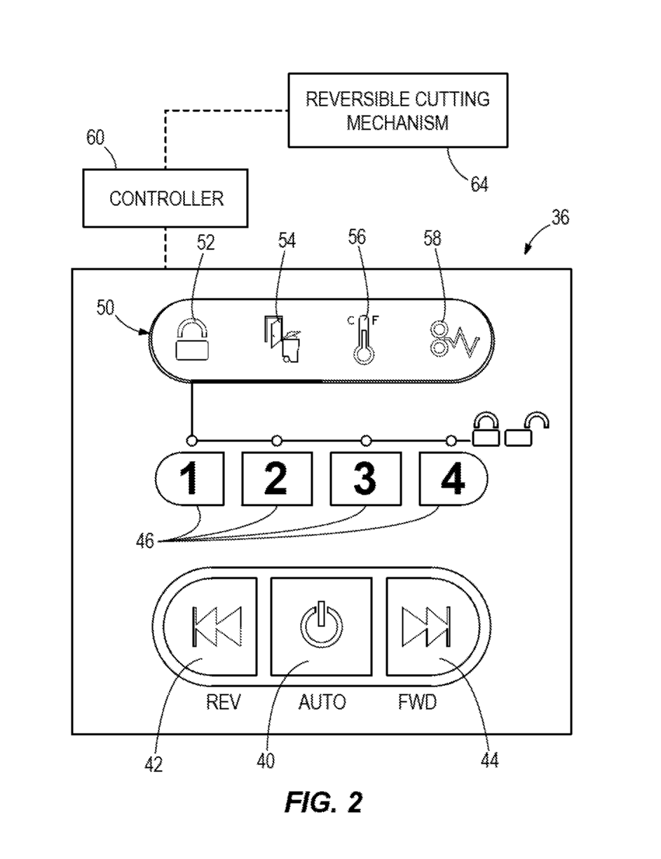

FIGS. 1 and 2 illustrate a shredding machine or shredder 20. The shredder 20 includes a housing 24 defining an enclosure within which a cutting mechanism 64 is positioned. The cutting mechanism 64 can include a set of parallel shafts with interleaved cutting blades, or another type of cutting mechanism configured to cut up material such as paper, credit cards, etc. fed therein. The cutting mechanism 64 is drivable by one or more electric motors, or another drive source, to operate the cutting mechanism 64. With the auto-feed shredder 20, material to be shredded is placed into an auto-feeding tray or bin by lifting a lid or access door 28 of the housing 24. The lid 28 can be lockable to prevent unauthorized access to the material deposited into the auto-feed tray. A feed mechanism automatically delivers the material from the auto-feed tray to the cutting mechanism 64. Once shredded, the material is delivered from the cutting mechanism 64 to a collection bin 32. In some constructions, the collection bin 32 is accessed by a door 32A of the housing 24. Although the shredder 20 has auto-feed capability, a manual-feed slot 34 is also provided, which bypasses the auto-feed tray to deliver material directly to the cutting mechanism 64 as manually inserted by a user. The shredder 20 also includes a communication module 102 which is discussed in further detail below.

On a front or top side of the shredder 20, an interactive user interface 36 is provided. FIG. 2 provides a detail view of the interactive user interface 36. The interface 36 includes a plurality of visual indicators (e.g., lights, icons, etc.) and a plurality of user-operable controls. The controls include a power/auto control 40, a reverse direction control 42, a forward direction control 44, and a series of PIN-code entry controls 46. The series of PIN-code entry controls 46 are used by the user to control various features (e.g., auto-feed bin lock, etc.) of the shredder 20. Various users can present material to the shredder 20 and each user may be provided with a different PIN-code for accessing the shredder 20, as a means of user identification. Each PIN-code is associated with a set of contact information (e.g., e-mail, phone number, fax number) for each user. The shredder 20 may also include other various user identification methods, such as passwords, biometric authentication (e.g., finger prints, voice control, etc.), swipe cards (e.g., RFID cards), Bluetooth device options, Near Field Communication (NFC) technologies, etc., all of which may be utilized to provide an identification code associated with a particular user to identify the individual or a particular group to which the individual belongs. Depending on the type of user identification method used, a corresponding reader (e.g., card reader, fingerprint scanner, etc.) would be located at or formed with the shredder 20 for utilizing the chosen identification method. In the illustrated construction, each of the controls 40, 42, 44, 46 is provided by an individual push-button. In other constructions, the controls may be provided by other types of controls, including multi-function switches, slider switches, rocker switches, dials, etc.

The interface 36 further includes a display 50 having a plurality of illuminable indicators, which in the illustrated construction include a first icon 52 for indicating a locked condition of the lid 28, a second icon 54 for indicating that the collection bin door 32A is open, a third icon 56 for indicating overheating of the motor that drives the cutting mechanism 64, and a fourth icon 58 for indicating that a jam has occurred in the cutting mechanism 64. Further indicators are provided by lighting associated with one or more of the user controls 40, 42, 44, 46. In the illustrated construction, this includes lighting configured to illuminate (e.g., backlight) each of the individual push-buttons 40, 42, 44, 46 directly. In other constructions, lighting associated with the user controls 40, 42, 44, 46 can include lighting adjacent one or more of the user controls 40, 42, 44, 46. Adjacent lighting can take the form of a simple light source (e.g., LED), or lighting (e.g., backlighting) of a label such as a picture, symbol, word, etc. associated with one or more of the user controls 40, 42, 44, 46. As shown schematically in FIG. 2, the interactive user interface 36 is coupled to a controller 60, which is coupled to the cutting mechanism 64 to control the operation of the cutting mechanism 64. The controller 60 can include a memory configured to store various pieces of information or parameters relating to operation of the shredder 20.

When the shredder 20 is off, actuation of the power/auto control 40 turns the shredder on and puts the shredder into an automatic or “auto” mode in which the cutting mechanism 64 is operated automatically in response to the presence of paper or other material to be shredded. During shredding in the auto mode, a user is not required to actuate either of the reverse or forward direction controls 42, 44, and the shredder 20 will simply run in the forward shredding direction as long as material is present to shred. The power/auto control 40 may be illuminated (e.g., blue backlighting) whenever the shredder 20 is on.

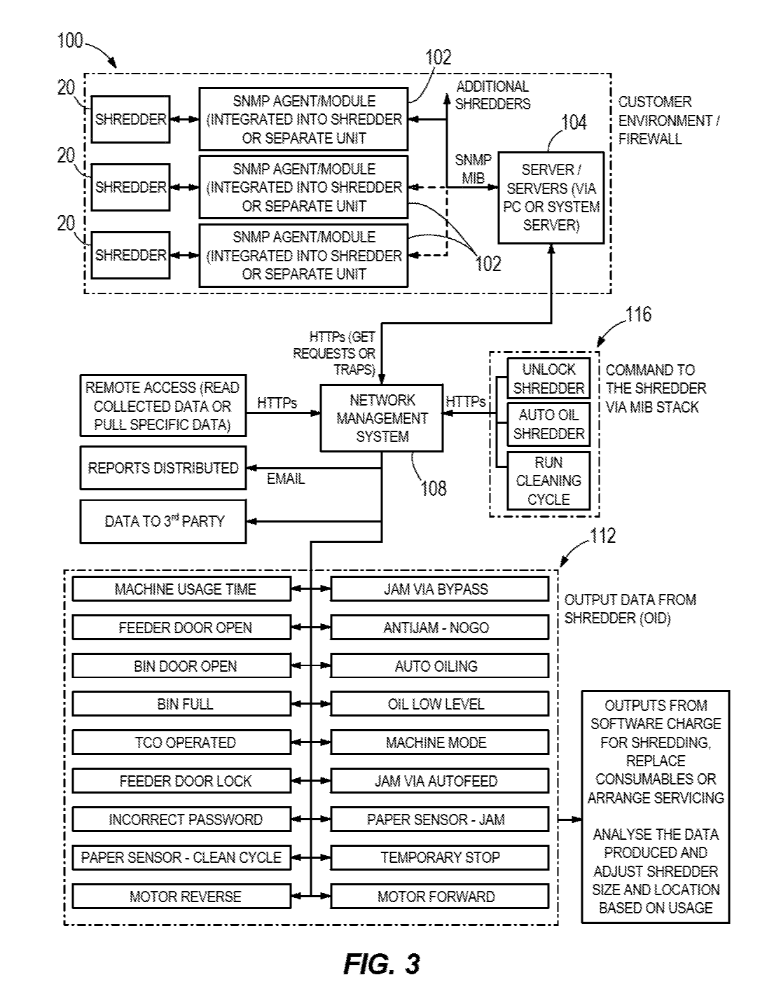

FIG. 3 illustrates a shredder network 100 including a plurality of communication-enabled shredders 20, a server system 104, and a network management system 108. The plurality of shredders 20 illustrated in FIG. 3 may be of the type illustrated in FIGS. 1 and 2; however, the plurality of shredders 20 may also be of other types having different construction, size, capacity, and/or features. In reference to FIG. 1, each of the shredders 20 may have an integrated communication module 102 located within the housing 24 of the shredder. Alternatively, one or more of the shredders 20 may connect to an external communication module (not shown) provided outside the housing 24 of the shredder which may be configured to adapt existing non-communication enabled shredders to have communication capabilities. The external communication module may include an LCD display and key entry panel for inputting various commands by the user. Although the remaining description makes specific reference to an integrated communication module, it will be understood that an external communication module can provide the same or similar function.

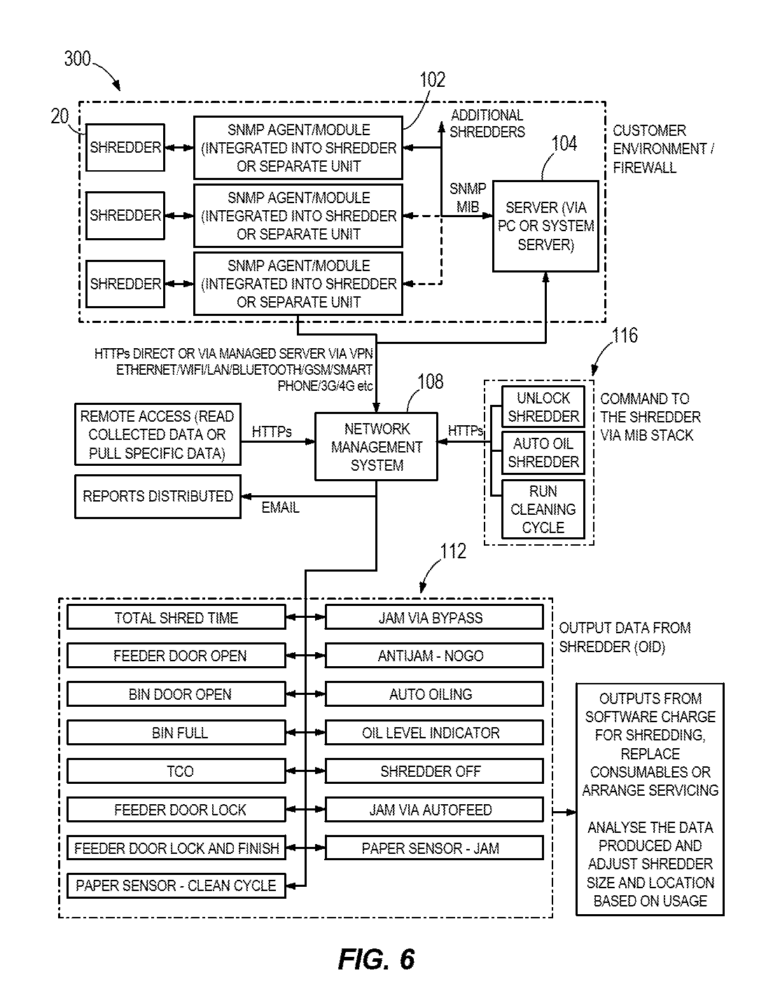

The internal communication module 102 can establish data communication between the shredders 20 (i.e., the shredder controllers) and the rest of the shredder network 100 using one of a variety of connection methods and communication protocols. Possible connection methods include, but are not limited to, a wireless internet connection (WiFi), Local Area Network (LAN), Bluetooth, Global System for Mobile Communications (GSM), 3G, 4G, etc. Possible communication protocols include, but are not limited to, Simple Network Management Protocol (SNMP) or Hypertext Transfer Protocol Secure (HTTPS). SNMP requires the use of Management Information Base files (MIBs) to read the SNMP data. MIBs are a collection of definitions used to define the objects managed within the device (e.g., shredder). Additionally Object Identifiers files (OIDs) address each of the entries or features from the MIB in more detail. All products which use SNMP include two groups of MIBs, public and private. For the internal communication module 102, a majority of the features from the OIDs are defined in the private MIB file. Only general system features of the OIDs are defined in the public MIB file. The features of the OIDs defined in the private MIB relate to non-standard network features such as various output signals discussed in more detail below (e.g., shredder jammed, motor run time, etc.). The communication module 102 generally transmits information to and receives information from the server system 104 while the server system 104 is in communication with the network management system 108. The communication module 102 may also communicate directly with the network management system 108 without having to communicate through the server system 104 (FIG. 6).

While only one server system 104 is illustrated, the network management system 108 is capable of communicating with a plurality of server systems 104 located at various unique geographic locations (e.g., different businesses or business locations). The unique geographic locations may be separate shredding areas within a single office building, separate office buildings or retail/service store fronts, separate buildings in different cities, states, or countries, or any geographic locations which are separated in a manner which would make a shredder network with wireless communication capabilities desirable. Further, multiple network management systems 108 may be provided to analyze the data from the plurality of server systems 104. The network management system 108 may be owned and/or operated by a first entity that monitors the shredders 20, which are in the possession of a second entity (or a plurality of entities) different from the first entity. The first entity may be a shredder provider, and the second entity or plurality of entities may be a client or clients that obtain (e.g., purchase, rent) shredders from the shredder provider.

The server system 104 may be any type of server or system of servers suitable for storing the information received or a set of output data 112 from the communication module 102 of the shredders 20 or a set of command signals 116 from the network management system 104. The server system 104 may be owned and/or operated by the second entity (i.e., client) or one of the plurality of entities indicated above and further provided within a working environment (e.g., commercial, retail, private office environment) of the second entity. Additionally, the illustrated server system 104 is protected by a network firewall provided by the second entity. Alternatively, the server system 104 may be owned and/or operated by the first entity (e.g., shredder provider) which owns and/or operates the network management system 108, and the server system 104 may be provided in the working environment of the first entity.

In order to process and analyze the collected data, the network management system 108 is in communication with the server system 104, and the network management system 108 may access or receive information from the server system 104 in various ways. The network management system 108 may request information from the server system 104 or the shredders 20 by sending GET Requests to the server system 104 or the shredders 20 through one of the previously mentioned communication protocols. The GET requests periodically pull data from the server system 104 or the shredders 20 at a set interval (e.g., 1 minute). The server system 104 or the shredders 20 may also transmit information to the network management system 108 using trap functions. Trap functions automatically transmit information from the server system 104 or the shredders 20 to the network management system 108 when the status of a signal changes.

The output data 112 is remotely accessible for viewing by authorized personnel or administrators of the first entity. The authorized personnel or administrators can remotely access the output data 112 using one or more log-in methods. As an example, the administrators may access the information from a web interface which requires the administrator to provide a username and password. Alternately, or in addition, the network management system 108 may automatically distribute reports (e.g., via e-mail, text messages, dashboard views, etc.) to the administrators or other authorized personnel for viewing. The reports may also be stored in the network management system 108 for later viewing. The network management system 108 may also send error alerts to authorized personnel. The error alerts would be triggered by one of the shredders 20 entering an ‘error’ state, as defined by a specific user. As an example, the network management system 108 may notify an authorized person that one of the shredders 20 has been jammed (i.e., an ‘error’ state) for 30 minutes. The authorized person would then be able to coordinate machine maintenance. Other methods for viewing the information collected are also possible.

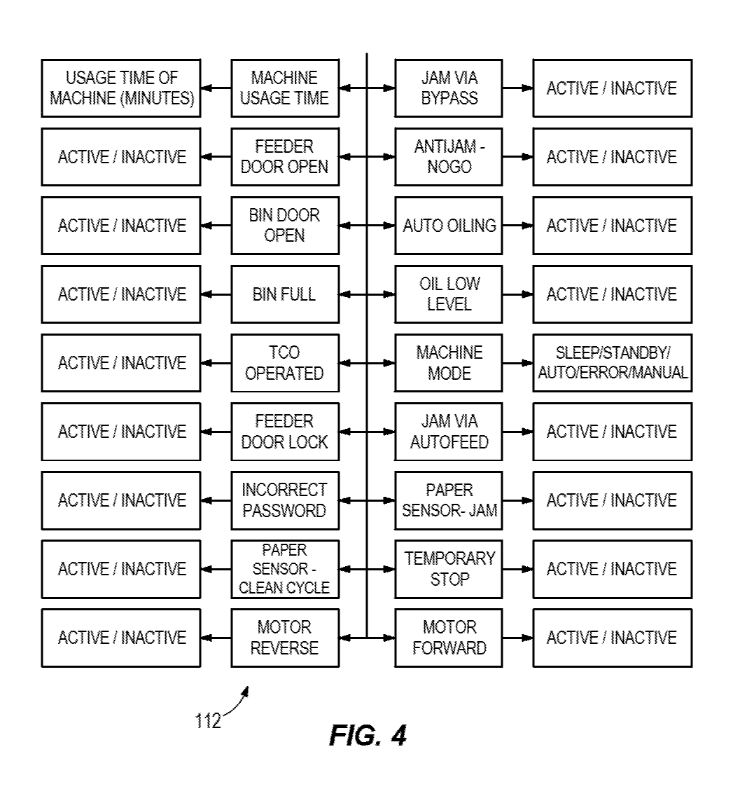

In reference to FIGS. 3-5, the information collected by the network management system 108 includes the output data 112 having several types of signals from the plurality of shredders 20. The output data 112 from the shredders 20 is generally the same as the data recorded and stored within the memory of the shredder 20 as controlled by the on board controller 60. Some of the output data 112 may be collected by a plurality of sensors (not shown), such as an oil level sensor. Various signals of the output data 112 may include a binary state (e.g., active or inactive) while other signals may indicate other states (e.g., machine modes). Counters may be added to each signal to count the number of times a signal has been active, inactive, or in some otherwise indicated state. The output data 112 from the shredder 20 may include, but is not limited to, any one or combination of the following types of data or signals: a machine usage time (e.g., in minutes), feeding tray door open, storage bin door open, storage bin fullness level, thermal cut off (TCO), feeding tray door locked, incorrect password entry, paper sensor clean cycle signal, antijam-NoGo, oil level indicator, auto oiling indicator, machine mode, temporary stop, paper jam by means of auto-feed or manual-feed, paper sensor jam signal, motor forward and reverse, identification codes which have been used, types of paper shredded (e.g., glossy, matte, etc.), media type shredded (e.g., CDs, credit cards, etc.), load on cutters or motor current, amount of paper in the feeding tray/chamber, usage amounts of the feeding tray/chamber and the manual feed slot/chute, storage bin and feeding tray fullness, usage times, peak times of shredder usage, shredding complete alert sent to user, machine ID, data from all sensors, system resets, shredder operating temperature, noise levels, vibration levels, machine power usage, count of paper fasteners (e.g., staples, paperclips, etc.) removed during shredding, number of bound documents (e.g., magazines) shredded, camera video footage, and storage bin fullness levels via the camera. Further description of some of the features related to the output data signals 112 is provided below. The thermal cut off (TCO) temporarily shuts down the shredder motor in the event of overheating. The clean cycle automatically runs the cutters 64 in forward and reverse to eject excess paper when no more paper is detected in the auto-feed tray by a paper sensor. The antijam-NoGo refers to the triggering of an antijam sensor in the manual feed chute for the purposes of jam prevention. The machine mode feature indicates what operation mode (e.g., sleep, standby, auto-feed, manual-feed, error, etc.) the shredder 20 is in. The paper sensor jam feature detects paper slippage in the auto-feed tray as indicated by the paper sensor.

The output data 112 collected by the network management system 108 may be used to provide additional services to a client, such as arranging shredder servicing or maintenance by notifying the first entity (i.e., shredder manufacturer) or a third entity that the storage bin is at or near a full level. As an example, the total shred time (i.e., run-time of motor) may be used to generate an invoice from the first entity to the second entity for provided shredding services. Additionally, or in the alternative, other types of output data 112 (e.g., the number of times the bin fullness level indicates that the bin was full, the number of times an oil level warning is triggered indicative of a quantity of lubricating oil being used up, etc.) may be used to generate invoices. In some instances, this would allow the invoices to include charges related to consumable products (e.g., oil cartridges), which may be automatically scheduled for replacement. By providing the shredder(s) 20 with a user identification system, as discussed above, charges may be separately allocated (and invoices generated) for separate business sub-departments or budget cost centers associated with an identified user, or for each individual user. The usage and cost may be tracked, and corresponding invoices generated, on the basis of each individual shredder 20, or on the basis of some or all the shredders 20 within the shredder network 100 as a whole. An E-certificate of destruction may be sent (e.g., via e-mail, text message, etc.) to the user of the shredder 20 to provide them with verification that paper inserted into the auto-feed tray has been destroyed. The method of sending the E-certificates of destruction is determined and stored in reference to the user's unique ID. Additionally, the shredder may provide the user with the ability to remotely unlock the auto-feed tray or keep the auto-feed tray locked until they manually enter their unique ID on the shredder interface 36. Additionally, the storage bin fullness data may be used to trigger a shredded paper pickup from the shredder 20. The oil level indicator data may be used to initiate replacement of the oil once the oil level reaches a certain level. Furthermore, the usage data may be used to prompt upsizing or downsizing the shredder(s) 20 or the number of shredders 20 at a particular shredding location.

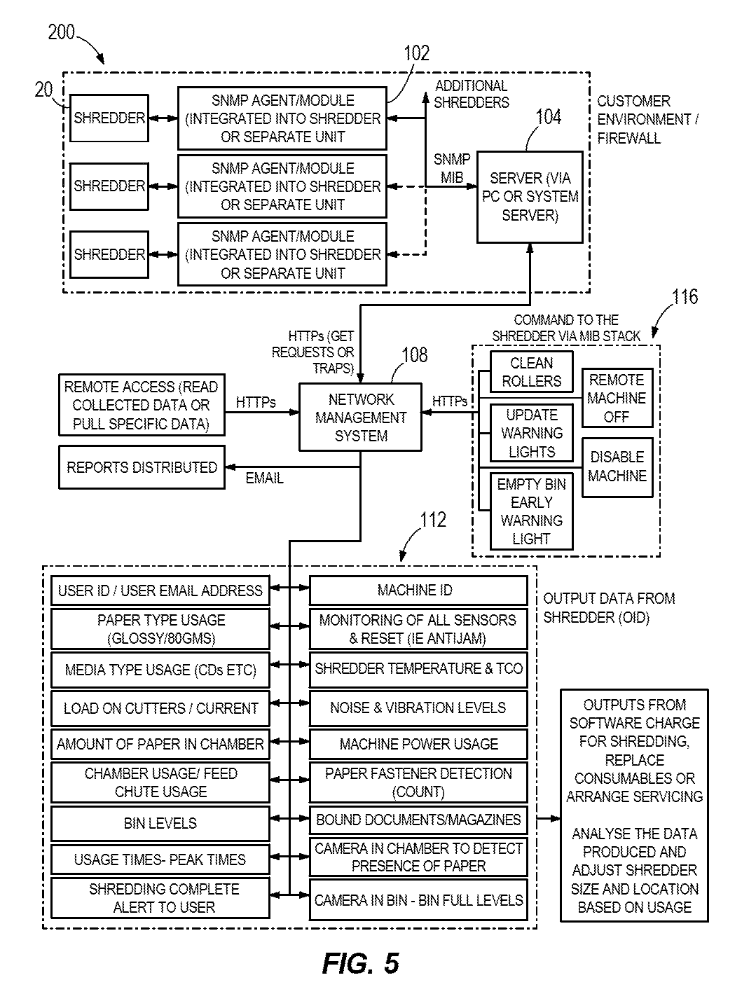

The network management system 108 may send command signals 116 to the shredders 20 through the server system 104 and the communication module 102. The network management system 108 may also send the command signals 116 to the shredder 20 by communicating directly with the communication module 102 and not through the server system 104 (FIG. 6). Further, the server system 104 may be able to send commands to the shredders 20. The command signals 116 may be used to remotely control or operate various features of the shredders 20 which generally are controlled by the controller 60 on board the shredder 20 and available via the user interface 36. In reference to FIGS. 3 and 5, some of the command signals 116 may include any one or combination of the following signals: cleaning the rollers, resetting/updating the warning lights, controlling an empty bin early warning light, disabling the machine, remotely turning off the machine, an auto-unjam sequence, an automatic oil sequence, and a shredder cleaning cycle. The command signals 116 may be sent automatically by the network management system 108 in response to one or more signals from the output data 112. The command signals 116 may also be sent at the discretion of an administrator upon receiving information from the shredder(s).

A user may also be able to connect a mobile device (e.g., cellular phone, tablet, etc.) to one or more of the shredders 20 or the server system 104 through wireless communication such as, for example, Bluetooth, WiFi, ZigBee, Z-Wave, Infra-red (IR), etc. The mobile device may be used to give real-time status information of particular shredders 20 (e.g., which are in use, which are free) or other user information regarding the status of the shredder network 100. In such an instance, the communication module 102 of the shredder(s) 20 may include a wireless transceiver that is capable of communicating directly with the mobile device.

FIG. 5 illustrates a shredder network 200 similar to the shredder network 100. The shredder network 200 functions substantially the same as the shredder network 100, but the shredder network 200 includes output data 112 having different types of data or signals than the output data 112 of the shredder network 100. FIG. 6 illustrates a shredder network 300 similar to the shredder networks 100, 200. The shredder network 300 functions substantially the same as the shredder networks 100, 200 except that the communication module 102 may be configured or connected for directly communicating with the network management system 108. In the case of any of the shredder networks described and illustrated herein, it should be noted that, while certain functions and advantages may be provided with two or more shredders connected to the network, it is also contemplated that any given network may also be established with a single shredder.

Various features and advantages of the invention are set forth in the following claims.

What is claimed is:

1. A shredder network comprising:
a server system;
a network management system in communication with the server system for processing information; and
a plurality of shredders, each of the plurality of shredders including
a cutting mechanism operable to shred material fed thereto,
a controller which receives information from a plurality of sensors, and
a communication module establishing communication protocol between the shredder and one of the server system or the network management system.

2. The shredder network of claim 1, wherein the communication modules are integrated into the plurality of shredders.

3. The shredder network of claim 1, wherein the communication modules are external communication modules removably connectable to the plurality of shredders.

4. The shredder network of claim 1, wherein the server system includes a plurality of servers located at a plurality of unique geographic locations.

5. The shredder network of claim 1, wherein the communication module is configured to communicate using SNMP or HTTPS.

6. The shredder network of claim 1, wherein each of the plurality of shredders is configured to be operated locally by using an interface on the shredder and configured to be operated remotely via the network management system.

7. The shredder network of claim 1, wherein one of the plurality of shredders further includes a reader operable to identify different users.

8. The shredder network of claim 1, where the communication module includes a wireless transceiver operable to communicate directly with a mobile device.

9. A method comprising:
providing a plurality of shredders for shredding materials;
collecting information from each of the plurality of shredders;
storing the information collected from the plurality of shredders;
sending at least a portion of the information collected from the plurality of shredders to a network management system; and
analyzing the information collected to provide services;
wherein the services include generating an invoice based on the information collected.

10. The method of claim 9, wherein sending information to the network management system includes communicating via a communication module.

11. The method of claim 9, wherein at least a portion of the information collected from the plurality of shredders is sent to the network management system through a server system.

12. The method of claim 11, wherein the network management system is operated by a first entity and the server system is operated by a second entity.

13. The method of claim 11, wherein the network management system is operated by a first entity and the server system is operated by a plurality of entities that are not the first entity.

14. The method of claim 13, wherein the plurality of shredders are provided at unique locations operated by the plurality of entities.

15. The method of claim 11, wherein the network management system and the server system are operated by a single entity.

16. The method of claim 9, further comprising providing remote access to the information collected.

17. The method of claim 9, further comprising generating a report including at least a portion of the collected information.

18. The method of claim 17, further comprising e-mailing the report to one of a first entity or a second entity.

19. The method of claim 9, wherein the collected information includes one or more of a total shred time, a measured quantity of accumulated materials in a storage bin, or oil usage of each of the plurality of shredders.

20. The method of claim 19, wherein generating the invoice includes calculating a charge amount based on the total shred time measured.

21. The method of claim 19, wherein generating the invoice includes calculating a charge amount based on the measured quantity of accumulated materials in the storage bin.

22. The method of claim 19, wherein generating the invoice includes calculating a charge amount based on the oil usage.

23. The method of claim 19, further comprising sending a shredded paper pickup request in response to the quantity of accumulated materials in the storage bin.

24. The method of claim 9, further comprising sending a command signal from the network management system to one of the plurality of shredders to initiate a maintenance operation.

25. The method of claim 24, wherein the maintenance operation includes at least one of unlocking a shredder storage bin, oiling the shredder, disabling the shredder, and running a cleaning cycle.

26. The method of claim 9, further comprising identifying a user of one of the plurality of shredders based on a user identification code associated with the user, and sending a confirmation of destruction to the user once the materials have been successfully shredded.

27. The method of claim 9, further comprising identifying a user of one of the plurality of shredders based on a user identification code associated with the user, and generating multiple invoices based on different user identification codes.

28. The method of claim 9, further comprising monitoring the status of one of the plurality of shredders wirelessly using a mobile a device.
